(19) United States
(12) Patent Application Publication
(10) Pub. No.: US 2010/0177230 A1
(43) Pub. Date: Jul. 15, 2010

(54) IMAGE SENSOR DRIVING APPARATUS

(75) Inventors: Akihisa Himeno, Osaka (JP); Akira Tanaka, Kyoto (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/376,643

(22) PCT Filed: Aug. 2, 2007
(86) PCT No.: PCT/JP2007/065174

§ 371 Date: Feb. 6, 2009

(30) Foreign Application Priority Data
Aug. 9, 2006 (JP) 2006-216981

(51) Int. Cl. H04N 5/335

(52) U.S. Cl. 348/308; 348/311; 348/E05.091

(57) ABSTRACT

An image sensor driving apparatus is provided with a plurality of output blocks having the functions of both a binary output block and a ternary output block and, therefore, is adaptable to image sensors with various types of specifications. The image sensor is provided with a plurality of dual-purpose binary/ternary output blocks having the functions of both a binary output block and a ternary output block and is configured to change over between binary operations and ternary operations, according to driving/controlling signals from a timing generator or selection signals from the outside of the apparatus.

THIS APPLICATION IS A U.S. NATIONAL PHASE APPLICATION OF PCT INTERNATIONAL APPLICATION PCT/JP2007/065174.

### TECHNICAL FIELD

The present invention relates to an image sensor driving apparatus for driving an image sensor and, more particularly, relates to an image sensor driving apparatus for driving vertical registers in an image sensor.

### BACKGROUND ART

FIG. 12 is a block diagram illustrating the schematic structure of a common image pickup apparatus having a CCD image sensor, such as an image pickup apparatus 100 used in a digital still camera. As illustrated in FIG. 12, the image pickup apparatus 100 is provided with an optical block 101 having optical instruments such as a lens, a diaphragm mechanism and a shutter mechanism, a CCD image sensor 102 which receives light from the optical block 101 and converts it into electrical signals, an AFE (Analog Front-End) 103 which digitalizes electrical signals from the CCD image sensor 102, an image processing portion 104 which receives digital signals inputted thereto from the AFE 103 and outputs image signals, an optical-block control portion 105 which controls the diaphragm mechanism, the shutter mechanism and the like of the optical block 101, a vertical driver 106 which drives and controls vertical registers of the CCD image sensor 102, and a timing generator 7 which outputs driving/controlling signals to the CCD image sensor 102, the AFE 103, the optical-block control portion 105 and the vertical driver 106 by receiving synchronization signals and the like which are inputted thereto from the image processing portion 104. In this case, the AFE 103 is configured to include a CDS (Correlated Double Sampling), an AGC (Automatic Gain Control), and an ADC (Analog Digital Converter).

The CCD image sensor 102 includes photo diodes which convert light from the optical block 101 into electric charges, and vertical registers and a horizontal register for transferring the electric charges resulted from the conversion to the AFE 103. In order to drive the vertical registers and the horizontal register in the CCD image sensor 102, it is necessary to generate respective driving signals having vertical driving pulses and horizontal driving pulses. The driving signals for driving the horizontal register of the CCD image sensor 102 are directly inputted from the timing generator 107. The vertical driving pulses for driving the vertical registers are required to have a higher voltage than that of the horizontal driving pulses and, therefore, there are provided the vertical driver 106 for generating the vertical driving pulses. As the voltage of the vertical driving pulses, there is a need for providing three types of voltages which are a High-level voltage (for example, +12 V) for transferring the electric charges accumulated in the photo diodes to the vertical registers, and a Middle-level voltage (for example, 0 V) and a Low-level voltage (for example, −6V) for successively transferring the electric charges transferred to the vertical registers through the vertical registers and, then, transferring them to the horizontal register. The vertical driver 106 converts the driving/controlling signals from the timing generator 107 into vertical driving pulses for driving the vertical registers in the CCD image sensor 102. On the other hand, driving/controlling signals generated by the timing generator 107 are used as the horizontal driving pulse (at a voltage of +3.3 V, for example) and are directly inputted to the CCD image sensor 102.

FIG. 13 is a block diagram illustrating the schematic internal structure of a conventional vertical driver 106. As illustrated in FIG. 13, the vertical driver 106 includes two types of output blocks which are binary output blocks 200 and ternary output blocks 300. Required numbers of binary output blocks 200 and ternary output blocks 300 are provided, according to the specifications of the CCD image sensor 102, such as the number of pixels, the driving mechanism and the like. A single binary input signal which is a driving/controlling signal from the timing generator 107 is inputted to each binary output block 200, so that each binary output block 200 generates a single binary driving signal to be outputted to the CCD image sensor 102. Two ternary input signals which are driving/controlling signals from the timing generator 107 are inputted to the ternary output blocks 300, so that the ternary output blocks 300 generate a single ternary driving signal to be outputted to the CCD image sensor 102.

FIG. 14 is a block diagram illustrating the internal structures of a binary output block 200 and a ternary output block 300 in the conventional vertical driver 106. The binary output block 200 converts the driving/controlling signal from the timing generator 107 into a desired Middle-level voltage (for example, 0 V) or a desired Low-level voltage (for example, −6 V) and outputs it as a binary driving signal to the vertical register in the CCD image sensor 102. The ternary output block 300 converts the driving/controlling signal from the timing generator 107 into a High-level voltage (for example, +12 V), a Middle-level voltage (for example, 0 V) or a Low-level voltage (for example, −6 V) and outputs it as a ternary driving signal to the vertical register in the CCD image sensor 102.

The binary output signals to be supplied to the binary output blocks 200, which are the driving/controlling signals from the timing generator 107, are inputted to a control circuit 201. The control circuit 201 outputs control signals to be outputted to a Low-level output driver 202 which outputs a Low-level voltage and a Middle-level output driver 203 which outputs a Middle-level voltage. Any driver, out of the Low-level output driver 202 and the Middle-level output driver 203, is excited, which causes any voltage, out of the Low-level voltage and the Middle-level voltage, to be outputted as a binary driving signal to the corresponding CCD.

Two types of driving/controlling signals, which are a first ternary input signal and a second ternary input signal, are inputted to the ternary output blocks 300. The first ternary input signal and the second ternary input signal are inputted to a control circuit 301. The control circuit 301 outputs control signals to a Low-level output driver 302 which outputs a Low-level voltage, a Middle-level output driver 303 which outputs a Middle-level voltage, and a High-level output driver 304 which outputs a High-level voltage, thereby exciting any of the output drivers 302, 303 and 304. As a result, the ternary output blocks 300 output a ternary driving signal having a desired output level to the corresponding CCD.

The ON resistances of the output transistors in the respective output drivers which are the Low-level output drivers 202 and 302 and the Middle-level output drivers 203 and 303 included in the binary output blocks 200 and the ternary output blocks 300 and the High-level output drivers 304 included in the ternary output blocks 300 are preliminarily set according to the CCD driving ability.

As described above, the vertical driver 106 in the conventional image pickup apparatus 100 has the plurality of binary output blocks 200 and the plurality of ternary output blocks 300 which are constituted by separated circuits. When the output levels of the binary output blocks 200 and the ternary output blocks 300 are both changed over, the rising waveforms and the trailing waveforms of the driving signals are moderate and not abrupt, due to the influences of the ON resistances of the output transistors and the load capacity of the CCD image sensor 102. Since the capacity value of the load capacity of the CCD image sensor 102 is varied, according to the number of pixels and the like, it has been necessary to set the device sizes (the ON resistances) of the output transistors in the respective output drivers in the vertical driver 106, such that they have optimum ON resistances suitable for the load capacity of the CCD image sensor 102.

Conventionally, when image pickup apparatuses are designed, individual vertical drivers have been developed and fabricated, such that they are adaptable to the numbers of channels and the driving mechanisms of the image sensors. Accordingly, there has been a need for designing the vertical driver according to the specifications of each image sensor, thereby increasing the number of developing processes and the fabrication cost.

Patent Document 1: Japanese Unexamined Patent Publication No. S 60-019315

### DISCLOSURE OF THE INVENTION

### Problems to be Solved by the Invention

As described above, conventional image pickup apparatuses have been configured to include a vertical driver having a plurality of binary output blocks and a plurality of ternary output blocks, which have required development of the vertical driver for each image sensor, thereby inducing the problem of increases of the number of development processes and the fabrication cost.

It is an object of the present invention to overcome the aforementioned problem in the conventional art and to provide an image sensor driving apparatus which is provided with a plurality of output blocks having the functions of both a binary output block and a ternary output block and, therefore, is adaptable to image sensors having various specifications.

### Means for Solving the Problems

In order to attain the aforementioned object, an image sensor driving apparatus according to the present invention is provided with dual-purpose binary/ternary output blocks having the functions of both a binary output block and a ternary output block. According to the present invention, a plurality of dual-purpose binary/ternary output blocks are provided according to the driving mechanism of an image sensor, which enables structuring a drive device adaptable to image sensors having various specifications. With the image sensor driving apparatus according to the present invention, it is possible to make the ON resistances of the output transistors in the vertical driver to be variable by selection control signals. This can provide a vertical driver with excellent general versatility, without providing changeover means with a low ON resistance in the output transistors.

The image sensor driving apparatus according to the present invention is provided with a plurality of dual-purpose binary/ternary output blocks having the functions of both a binary output block and a ternary output block, wherein the function of the binary output block or the ternary output block can be arbitrarily selected according to driving/controlling signals from a timing generator.

With the image sensor driving apparatus according to the present invention, since the plurality of dual-purpose binary/ternary output blocks are prepared, it is possible to arbitrarily set the dual-purpose binary/ternary output blocks as ternary output blocks or binary output blocks, according to driving/controlling signals from control circuits, according to the image sensor. This enables driving various types of CCD image sensors.

In the image sensor driving apparatus according to the present invention, the dual-purpose binary/ternary output blocks have a plurality of output-stage transistors which output a plurality of output level voltages, wherein the output-stage transistors are selectively caused to output the respective output level voltages, according to driving/controlling signals.

In the image sensor driving apparatus according to the present invention, the output transistors are configured to be controlled by an output selection logic circuit, in order to change the ON resistances of the output transistors which output the plurality of output level voltages, according to the device connected to output terminals. With the present invention, since the plurality of dual-purpose binary/ternary output blocks are prepared, it is possible to arbitrarily set the numbers of channels for binary output and ternary output, according to the number of channels in the image sensor.

An image sensor driving apparatus according to a first aspect of the present invention is an image sensor driving apparatus having a plurality of dual-purpose binary/ternary output blocks capable of outputting signals having binary or ternary voltage levels for driving an image sensor; wherein the dual-purpose binary/ternary output blocks includes a first voltage-level output driver which outputs signals having a first voltage-level, a second voltage-level output driver which outputs signals having a second voltage-level, and a third voltage-level output driver which outputs signals having a third voltage-level, the dual-purpose binary/ternary output blocks are configured to perform, according to driving/controlling signals inputted thereto, binary outputting operations for outputting signals having the second voltage level or the third voltage level, or ternary outputting operations for outputting signals having the first voltage level, the second voltage level or the third voltage level.

In an image sensor driving apparatus according to a second aspect of the present invention, the first voltage-level output driver, the second voltage-level output driver and the third voltage-level output driver according to the first aspect are each configured to include a plurality of output transistors, and are configured such that predetermined numbers of output transistors, out of the respective output transistors in the first voltage-level output driver, the second voltage-level output driver and the third voltage-level output driver, are activated according to the inputted driving/controlling signals.

In an image sensor driving apparatus according to a third aspect of the present invention, 3, the second voltage-level output driver and the third voltage-level output driver according to the first aspect are each configured to include a plurality of output transistors, and the second voltage-level output driver and the third voltage-level output driver are configured such that the plurality of output transistors therein are activated, when the dual-purpose binary/ternary output blocks perform binary outputting operations.

In an image sensor driving apparatus according to a fourth aspect of the present invention, the second voltage-level output driver according to the first aspect includes a binary dedicated second voltage-level output driver, the third voltage-level output driver includes a binary dedicated third voltage-level output driver and, only when the dual-purpose binary/ternary output blocks perform binary outputting operations, the binary dedicated second voltage-level output driver is activated together with the second voltage-level output driver, or the binary dedicated third voltage-level output driver is activated together with the third voltage-level output driver.

In an image sensor driving apparatus according to a fifth aspect of the present invention, a setting for causing the dual-purpose binary/ternary output blocks to perform binary outputting operations or ternary outputting operations is made, according to selection signals from an outside of the apparatus of the first aspect.

In an image sensor driving apparatus according to a sixth aspect of the present invention, the dual-purpose binary/ternary output blocks according to the fifth aspect include a storage device and are configured to store information about the selection signals indicative of whether the dual-purpose binary/ternary output blocks perform binary outputting operations or ternary outputting operations.

In an image sensor driving apparatus according to a seventh aspect of the present invention, the first voltage-level output driver according to the first aspect includes an ability adjustment first voltage-level output driver, the second voltage-level output driver includes an ability adjustment second voltage-level output driver, the third voltage-level output driver includes an ability adjustment third voltage-level output driver, and the image sensor driving apparatus is configured that the ability adjustment first voltage-level output driver, the ability adjustment second voltage-level output driver and the ability adjustment third voltage-level output driver are activated, according to the ability to drive the image sensor, according to driving/controlling signals from the outside of the apparatus, and that the dual-purpose binary/ternary output blocks are set to perform binary outputting operations or ternary outputting operations, according to selection signals from the outside of the apparatus.

In an image sensor driving apparatus according to an eighth aspect of the present invention, the dual-purpose binary/ternary output blocks according to the seventh aspect include a storage device and are configured to store information about the selection signals indicative of whether the dual-purpose binary/ternary output blocks perform binary outputting operations or ternary outputting operations.

In an image sensor driving apparatus according to a ninth aspect of the present invention, the first voltage level according to the first aspect is a High-level voltage, the second voltage level is a Middle-level voltage, and the third voltage level is a Low-level voltage, there is the relationship of the first voltage level>the second voltage level>the third voltage level, and the first voltage level, the second voltage level and the third voltage level are used for driving vertical registers of a CCD image sensor.

In an image sensor driving apparatus according to a tenth aspect of the present invention, the first voltage-level output driver, the second voltage-level output driver and the third voltage-level output driver according to the first aspect are constituted by N-channel or P-channel MOS transistors.

### EFFECTS OF THE INVENTION

The image sensor driving apparatus according to the present invention is provided with a plurality of dual-purpose binary/ternary output blocks having the functions of both a binary output block and a ternary output block, in such a way as to change over between binary output and ternary output through driving/controlling signals from the timing generator, and in such a way as to adjust the ON resistances of the output transistors by controlling the output transistors, which enables optimization of the characteristics of the output blocks according to the device to which the respective output levels are supplied. As a result, with the present invention, it is possible to eliminate the necessity of developing individual vertical drivers adaptable to various types of image sensors, thereby largely reducing the number of developing processes and the fabrication cost. Accordingly, with the image sensor driving apparatus according to the present invention, it is possible to change over between the functions of the binary and ternary output blocks which output respective voltage levels which have been preliminarily included in an LSI circuit (Large-scale Integrated circuit) for a single vertical driver, which can eliminate the necessity of designing an additional LSI for coping with the difference in the image-sensor driving mechanism, thereby reducing the number of developing processes and the fabrication cost.

### BRIEF DESCRIPTION OF THE DRAWINGS

FIG. 1 is a block diagram illustrating the schematic structure of an image pickup apparatus using an image sensor driving apparatus according to a first embodiment of the present invention.

FIG. 2 is a schematic structural diagram illustrating the internal structure of a CCD image sensor 2.

FIG. 3 is a block diagram illustrating the structure of a dual-purpose binary/ternary output block in a vertical driver 6 in the image pickup apparatus according to the first embodiment of the present invention.

FIG. 4 is a block diagram illustrating the structure of a single dual-purpose binary/ternary output block in a vertical driver 60 in an image pickup apparatus according to a second embodiment of the present invention.

FIG. 5 is a block diagram illustrating the structure of a vertical driver 70 and peripheral devices therefor in an image pickup apparatus according to a third embodiment of the present invention.

FIG. 6 is a view illustrating the cross-sectional structure of the CCD image sensor 2 having photo diodes 13 and vertical registers 14 illustrated in FIG. 5.

FIG. 7 is a timing chart of vertical driving pulses a1, a2, a3, b1, b2 and b3 which are driving signals inputted to the CCD image sensor 2.

FIG. 8 is a timing chart illustrating the relationship between the input and output voltage waveforms to and from a dual-purpose binary/ternary output block 71A in the vertical driver 70 illustrated in FIG. 5.

FIG. 9 is a timing chart illustrating the relationship between the input and output voltage waveforms to and from a dual-purpose binary/ternary output block 71B in the vertical driver 70 illustrated in FIG. 5.

FIG. 10 is a block diagram illustrating the structures of a vertical driver 91 and peripheral devices therefor in an image pickup apparatus according to a fourth embodiment of the present invention.

FIG. 11 is a block diagram illustrating the structures of a vertical driver 94 and peripheral devices therefor in an image pickup apparatus according to a fifth embodiment of the present invention.

FIG. 12 is the block diagram illustrating the schematic structure of the image pickup apparatus 100 used as the common image pickup apparatus having the CCD image sensor.

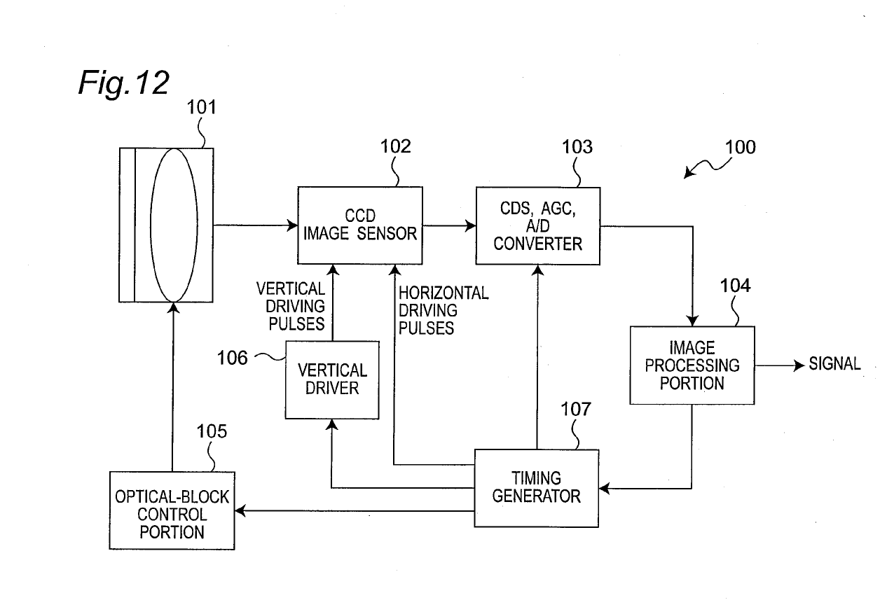

FIG. 13 is the block diagram illustrating the schematic internal structure of the conventional vertical driver 106.

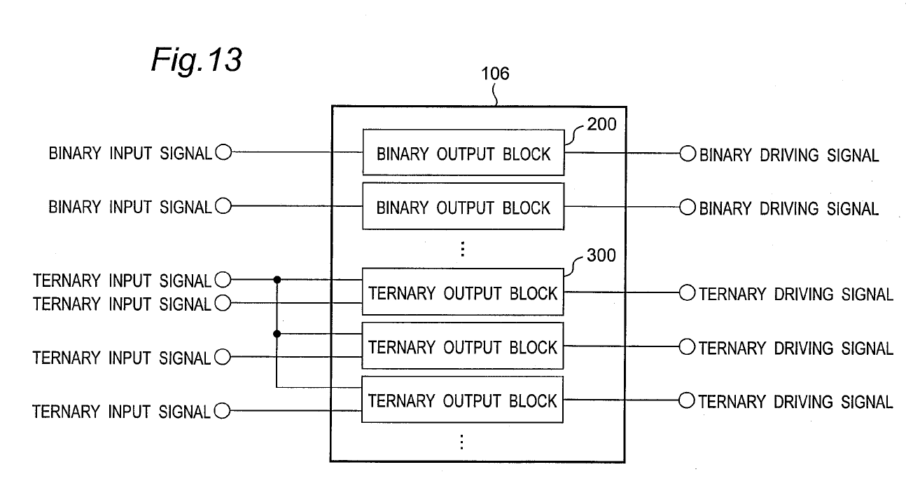

FIG. 14 is the block diagram illustrating the internal structures of the binary output block 200 and the ternary output block 300 of the conventional vertical driver 106.

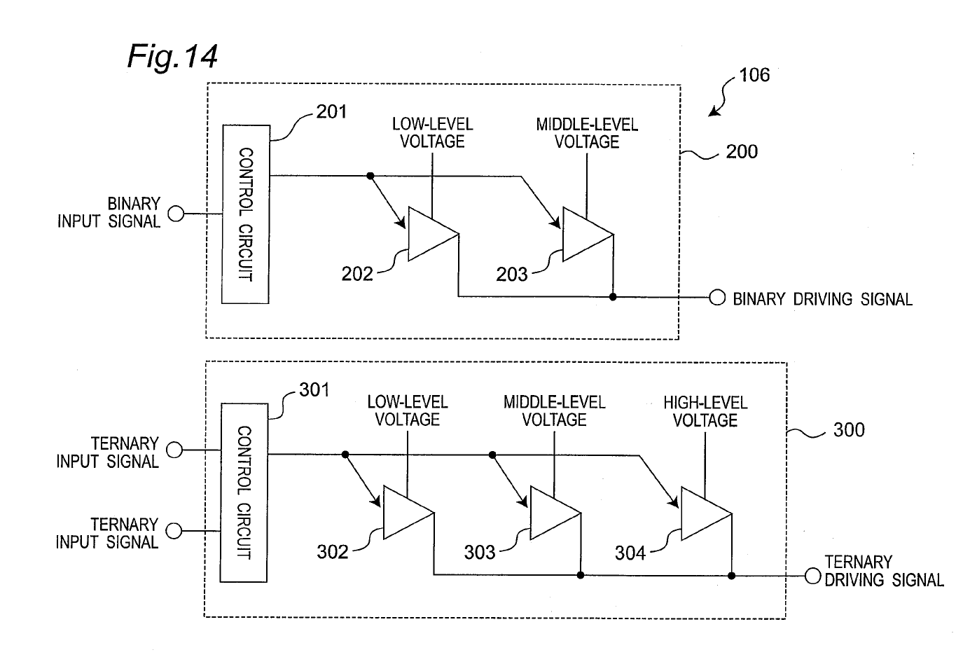

### DESCRIPTION OF REFERENCE CHARACTERS

1: Optical block

2: CCD image sensor

3: AFE

4: Image processing portion

5: Optical-block control portion

6: Vertical driver

7: Timing generator

20: First control circuit

21: Second control circuit

22, 23 and 24: CCD-driving-ability selection circuit

25: High-level output driver

26: Middle-level output driver

27: Low-level output driver

### PREFERRED EMBODIMENTS FOR CARRYING OUT THE INVENTION

Hereinafter, with reference to the accompanying drawings, preferred embodiments of an image sensor driving apparatus according to the present invention will be described, by exemplifying an image pickup apparatus using a CCD image sensor. Further, the technical concepts of the present invention are not limited to CCD image sensors and can be also applied to other image sensor driving apparatuses.

### First Embodiment

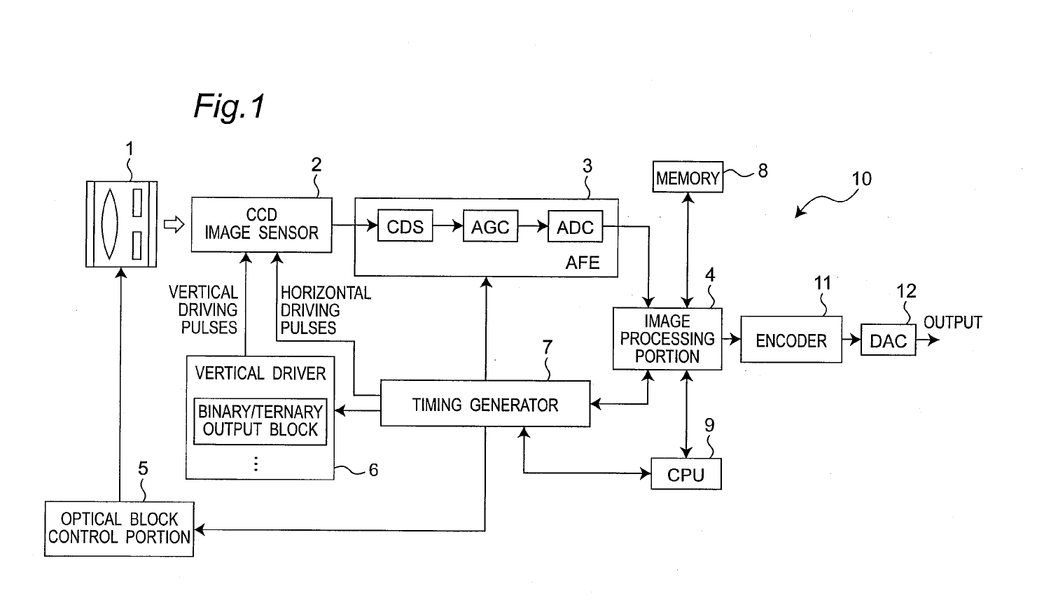

FIG. 1 is a block diagram illustrating the schematic structure of an image pickup apparatus using an image sensor driving apparatus according to a first embodiment of the present invention. The image pickup apparatus according to the first embodiment will be described, by exemplifying a digital still camera. As illustrated in FIG. 1, the image pickup apparatus 10 is provided with an optical block 1 having optical instruments such as a lens, a diaphragm mechanism and a shutter mechanism, a CCD image sensor 2 which receives light from the optical block 1 and converts it into electrical signals, an AFE (Analog Front-End) 3 which digitalizes electrical signals from the CCD image sensor 2, an image processing portion 4 which receives digital signals inputted thereto from the AFE 3, then performs image processing thereon and outputs image signals, an optical-block control portion 5 which controls the diaphragm mechanism, the shutter mechanism and the like in the optical block 1, a vertical driver 6 having dual-purpose binary/ternary output blocks which drive and control vertical registers of the CCD image sensor 2, and a timing generator 7 which drives and controls the CCD image sensor 2, the AFE 3 and the vertical driver 6 by receiving synchronization signals and the like which are inputted thereto from the image processing portion 4. In this case, the AFE 3 is configured to include a CDS (Correlated Double Sampling), an AGC (Automatic Gain Control), and an ADC (Analog Digital Converter). Further, the image pickup apparatus according to the first embodiment includes a memory 8 which stores data to be processed by the image processing portion 4, and a CPU (Central Processing Unit) 9 which performs operation processing for controlling the image processing portion 4, the timing generator 7 and the optical-block control portion 5, wherein image signals and the like from the image processing portion 4 are outputted through an encoder 11 and a D/A converter 12.

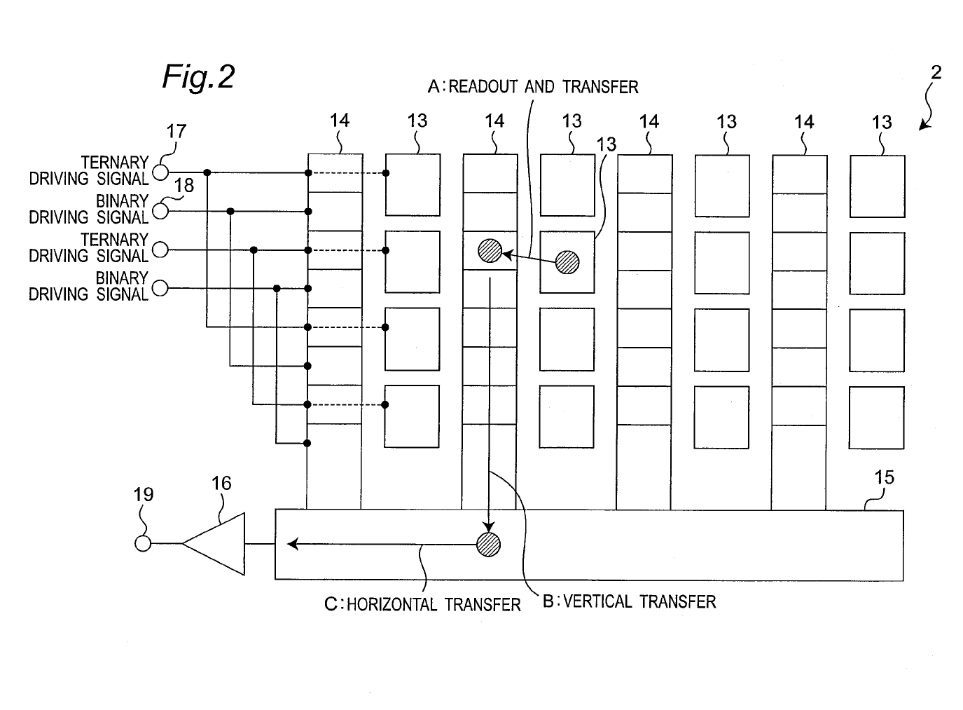

FIG. 2 is a schematic structural diagram illustrating the internal structure of the CCD image sensor 2. Referring to FIG. 2, the CCD image sensor 2 includes photo diodes 13 which convert light inputted from the optical block 1 into signal charges and accumulate them, vertical registers 14 which transfer the signal charges accumulated in the photo diodes 13 in the vertical direction (the top-to-bottom direction in FIG. 2), a horizontal register 15 which transfers the signal charges received from the vertical registers 14 in the horizontal direction (the right-to-left direction in FIG. 2), and an electric-charge-to-voltage conversion circuit 16 which receives the signal charges from the horizontal resistor 15 and converts them into voltages. The CCD image sensor 2 is provided with a plurality of ternary-driving-signals input terminals 17 and binary-driving-signals input terminals 18, according to the specifications of the CCD image sensor 2. Further, the electric-charge-to-voltage conversion circuit 16 is provided with an output terminal 19.

As illustrated in FIG. 2, as basic operations of the CCD image sensor 2, light inputted to the photo diodes 13 is converted into signal charges and the signal charges are accumulated therein and, thereafter, the signal charges are read therefrom and transferred to the corresponding cells of the vertical registers 14 (for example, they are transferred in the direction of an arrow A in FIG. 2). The signal charges transferred to the vertical registers 14 are successively transferred through the respective cells in the vertical direction (they are transferred in the direction of an arrow B in FIG. 2). Then, the signal charges which have been transferred in the vertical direction through the vertical registers 14 are then successively transferred through the respective cells of the horizontal register 15 in the horizontal direction (they are transferred in the direction of an arrow C in FIG. 2). The signal charges which have been transferred in the horizontal direction through the horizontal register 15 are transferred to the electric-charge-to-voltage conversion circuit 16 which converts them into voltages.

In order to perform readout and transfer (A) from the photo diodes 13 to the vertical registers 14, the High-level voltage of vertical driving pulses, such as voltage signals having +12 V, are used, wherein the vertical driving pulses are driving signals outputted from the dual-purpose binary/ternary output blocks of the vertical driver 6. In order to perform vertical transfer (B) through the vertical registers 14, a Middle-level voltage of vertical driving pulse such as voltage signals having 0V or a Low-level voltage of the vertical driving pulses such as voltage signals having −6V are used, wherein the vertical driving pulses are driving signals outputted from the dual-purpose binary/ternary output blocks.

The internal structure of the CCD image sensor 2 illustrated in FIG. 2 is a basic structure, and the structure thereof is varied according to the increase of the number of pixels, the variations of the driving mechanism, and the like. Further, the structure of the vertical driver 6 is varied, according to the specifications of the CCD image sensor 2.

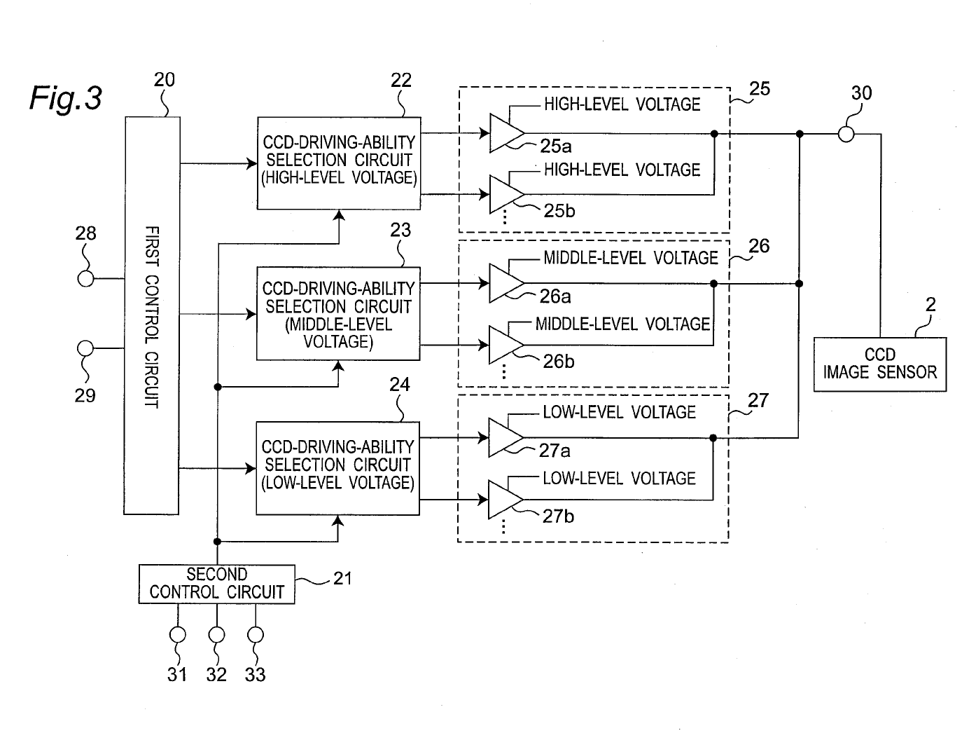

FIG. 3 is a block diagram illustrating the structure of a dual-purpose binary/ternary output block in the vertical driver 6 in the image pickup apparatus according to the first embodiment of the present invention. The vertical driver 6 is provided with a plurality of dual-purpose binary/ternary output blocks illustrated in FIG. 3, according to the specifications of the CCD image sensor 2. As illustrated in FIG. 3, each dual-purpose binary/ternary output block in the vertical driver 6 is provided with a first control circuit 20 and a second control circuit 21 and, also, is configured such that driving/controlling signals from the timing generator 7 are inputted thereto. Further, the dual-purpose binary/ternary output blocks are provided with a CCD-driving-ability selection circuit 22 and a High-level output driver 25 for generating a High-level voltage, a CCD-driving-ability selection circuit 23 and a Middle-level output driver 26 for generating a Middle-level voltage, and a CCD-driving-ability selection circuit 24 and a Low-level output driver 27 for generating a Low-level voltage. The High-level voltage, the Middle-level voltage and the Low-level voltage which are generated by the binary/ternary vertical driver 6 are outputted to the CCD image sensor 2 which is connected to the output terminal 30 for driving and controlling the vertical registers 14 of the CCD image sensor 2. In the first embodiment, the High-level voltage is +12 V, the Middle-level voltage is 0 V, and the Low-level voltage is −6 V. In the first embodiment, the CCD-driving-ability selection circuits 22, 23 and 24 for the High-level voltage, the Middle-level voltage and the Low-level voltage constitute a selection circuit.

The first control circuit 20 in the dual-purpose binary/ternary output block is provided with a first control terminal 28 and a second control terminal 29 to which driving/controlling signals are inputted from the timing generator 7. The second control circuit 21 is provided with three selection terminals 31, 32 and 33.

The control signals generated by the first control circuit 20 are inputted to the CCD-driving-ability selection circuit (the High-level voltage) 22, the CCD-driving-ability selection circuit (the Middle-level voltage) 23 and the CCD-driving-ability selection circuit (the Low-level voltage) 24 in the selection circuit 50.

Further, the determination as to whether the dual-purpose binary/ternary output blocks should function as binary output blocks or ternary output blocks is made according to the driving/controlling signals inputted from the timing generator 7. In the case where they function as binary output blocks, only the driving/control signals inputted to the first control terminal 28 are used, while, in the case where they function as ternary output blocks, the two types of driving/control signals inputted to the first control terminal 28 and the second control terminal 29 are used.

Further, the respective CCD-driving-ability selection circuits 22, 23 and 24 are controlled by selection signals from the second control circuit 21. Three types of driving/controlling signals, which are signals inputted from the outside, are inputted to the second control circuit 21, through the selection terminals 31, 32 and 33. The second control circuit 21 are connected to the CCD-driving-ability selection circuit (the High-level voltage) 22, the CCD-driving-ability selection circuit (the Middle-level voltage) 23 and the CCD-driving-ability selection circuit (the Low-level voltage) 24 and outputs selection signals to them.

The selection signals from the second control circuit 21 are used for varying the ON resistances of the output transistors in the High-level output driver 25, the Middle-level output driver 26 and the Low-level output driver 27, as will be described later.

The signals from the CCD-driving-ability selection circuit (the High-level voltage) 22, the CCD-driving-ability selection circuit (the Middle-level voltage) 23 and the CCD-driving-ability selection circuit (the Low-level voltage) 24 are inputted to the High-level output driver 25 to which the High-level voltage is inputted, the Middle-level output driver 26 to which the Middle-level voltage is inputted, and the Low-level output driver 27 to which the Low-level voltage is inputted, respectively. This results in excitation of the High-level output driver 25, the Middle-level output driver 26 or the Low-level output driver 27, which causes the High-level voltage (+12 V), the Middle-level voltage (0 V) or the Low-level voltage (−6 V) to be outputted to the CCD image sensor 2 through the output terminal 30.

As described above, in the vertical driver 6 of the image pickup apparatus according to the first embodiment, the High-level output driver 25, the Middle-level output driver 26 or the Low-level output driver 27 is driven by the control signals from the first control circuit 20, which causes the High-level voltage (+12 V), the Middle-level voltage (0 V) or the Low-level voltage (−6 V) to be outputted.

In each dual-purpose binary/ternary output block of the vertical driver 6 in the image pickup apparatus according to the first embodiment, the High-level output driver 25 is constituted by a plurality of output transistors 25a, 25b, . . . which are connected to one another in parallel. Similarly, the Middle-level output driver 26 is constituted by output transistors 26a, 26b, . . . which are connected to one another in parallel, and the Low-level output driver 27 is constituted by output transistors 27a, 27b, . . . which are connected to one another in parallel.

Each of the output transistors in the High-level output driver 25, the Middle-level output driver 26 and the Low-level output driver 27 has an ON resistance. In the dual-purpose binary/ternary output blocks in the vertical driver 6, each of the output drivers 25, 26 and 27 includes a plurality of output transistors and, therefore, it is possible to vary the ON resistance of the output transistors in each output driver 25, 26 or 27, by controlling the number of the output transistors being excited.

The output terminal 30 is connected to the CCD image sensor 2, and the CCD connected to the output terminal 30 has a capacitance. Accordingly, the rising time and the trailing time at the time of changeover of the output level voltages from the dual-purpose binary/ternary output blocks largely depend on the ON resistance of the output transistors in the dual-purpose binary/ternary output blocks. Assuming that the ON resistance of the output transistors is “R” and the capacitance of the CCD is “C”, the rising time and the trailing time at the time of changeover of the output level are determined by the time constant “RC”. The capacitance of the CCD is varied, according to the binary output structure, the ternary output structure and also according to the CCD driving mechanism and, therefore, it is necessary to set the ON resistance of the output transistors such that it is suitable for the CCD driving mechanism, in both of the cases of the binary output structure and the ternary output structure.

For example, in the case where the High-level voltage is outputted from the High-level output driver 25 to the output terminal 30, if only a single output transistor is used, it may be impossible to drive the CCD with the ON resistance of the output transistor. In this case, it is possible to make settings for driving the plurality of output transistors in the High-level output driver 25 in synchronization with one another by selection signals from the second control circuit 21, which enables driving the corresponding CCD. That is, with the structure according to the first embodiment, it is possible to increase the size of the output transistors in the High-level output driver 25 through selection signals, thereby setting a desired ON resistance.

Similarly, since the Middle-level output driver 26 and the Low-level output driver 27 are provided with the plurality of output transistors, it is possible to set the ON resistances of the output transistors such that they are suitable for the CCD driving mechanism, using selection signals.

As described above, in the vertical driver 6 in the image pickup apparatus according to the first embodiment, the dual-purpose binary/ternary output blocks function as binary output blocks which output the Middle-level voltage or the Low-level voltage or as ternary output blocks which output the High-level voltage, the Middle-level voltage or the Low-level voltage, according to the driving/controlling signals inputted to the first control circuit 20. Further, it is possible to set the ON resistance of the output transistors in each output driver 25, 26 or 27 to a desired value, using selection signals inputted to the second control circuit 21.

Further, the vertical driver 6 in the image pickup apparatus according to the first embodiment is basically configured such that a single output transistor is driven in each output driver 25, 26 or 27 and is configured such that a plurality of output transistors can be driven by selection signals as required.

As described above, with each dual-purpose binary/ternary output block of the vertical driver 6 according to the first embodiment illustrated in FIG. 3, it is possible to select an output level and a CCD driving ability, through control signals from the first control circuit 20 and selection signals from the second control circuit 21. Accordingly, with the vertical driver 6 in the image pickup apparatus according to the first embodiment, it is possible to structure a programmable vertical driver which enables changing over the functions of the dual-purpose binary/ternary output blocks through driving/controlling signals from the timing generator 7 and through selection signals. The selection signals can be signals inputted from the outside of the apparatus.

Further, in the first embodiment, the AFE 3, the vertical driver 6 and the timing generator 7 are constituted by semiconductor integrated circuits.

### Second Embodiment

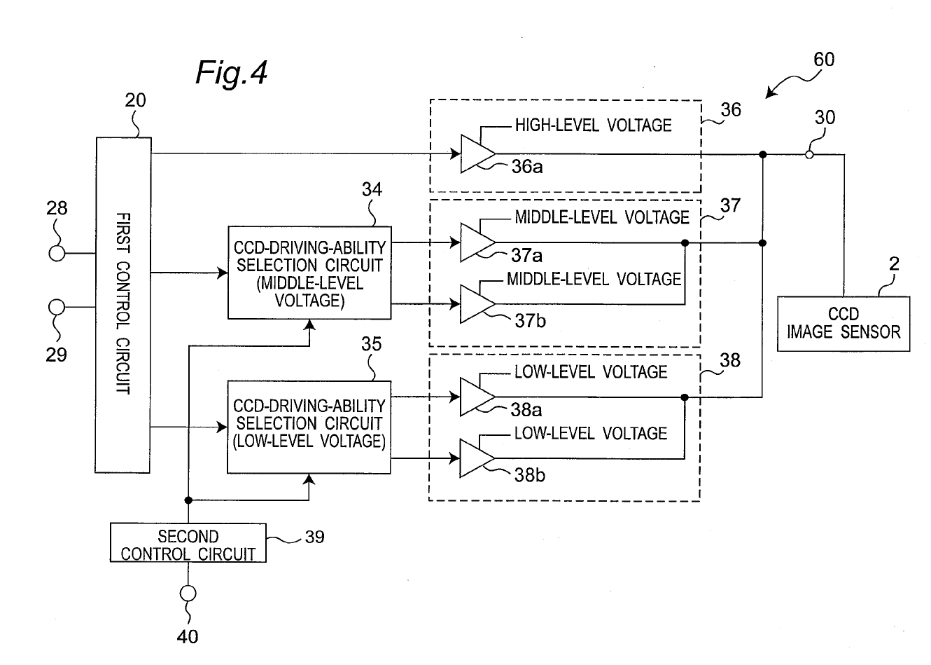

Hereinafter, with reference to FIG. 4, a second embodiment of the present invention will be described, with respect to an image pickup apparatus using an image sensor driving apparatus which is a semiconductor integrated device.

FIG. 4 is a block diagram illustrating the structure of a single dual-purpose binary/ternary output block in a vertical driver 60 in the image pickup apparatus according to the second embodiment of the present invention. In the image pickup apparatus according to the second embodiment, the structures of the other portions than the vertical driver 60 are the same as those of the image pickup apparatus according to the first embodiment illustrated in FIG. 1. In the second embodiment, the components having the same functions and structures as those of the components of the image pickup apparatus according to the aforementioned first embodiment will be designated by the same reference characters, and the description of the first embodiment will be applied thereto.

The vertical driver 60 in the image pickup apparatus according to the second embodiment is provided with a plurality of dual-purpose binary/ternary output blocks, according to the specifications of a CCD image sensor 2. The vertical driver 60 according to the second embodiment is provided with no CCD-driving-ability selection circuit for a High-level voltage and is configured such that control signals are directly inputted to a High-level output driver 36, unlike the vertical driver 6 according to the first embodiment. Further, the vertical driver 60 according to the second embodiment is provided with a CCD-driving-ability selection circuit 34 and a Middle-level output driver 37 for generating a Middle-level voltage, and a CCD-driving-ability selection circuit 35 and a Low-level output driver 38 for generating a Low-level voltage. The High-level voltage, the Middle-level voltage or the Low-level voltage which is a driving signal generated by the vertical driver 60 is outputted to the CCD image sensor 2 through an output terminal 30 for driving and controlling the vertical registers in the CCD image sensor 2.

In the vertical driver 60 in the image pickup apparatus according to the second embodiment, control signals from a first control circuit 20 are inputted to the High-level output driver 36 to which a High-level voltage is connected, the CCD-driving-ability selection circuit (the Middle-level voltage) 34 and the CCD-driving-ability selection circuit (the Low-level voltage) 35.

Further, the determination as to whether the dual-purpose binary/ternary output block function as binary output blocks or ternary output blocks is made according to driving/controlling signals inputted from a timing generator 7. In the case where they function as binary output blocks, only the driving/control signals inputted to a first control terminal 28 are used, while, in the case where they function as ternary output blocks, two types of driving/control signals inputted to the first control terminal 28 and a second control terminal 29 are used.

Selection signals, which are signals inputted from the outside of the apparatus, are inputted to a second control circuit 39, through a selection terminal 40. The second control circuit 39 is connected to the CCD-driving-ability selection circuit (the Middle-level voltage) 34 and the CCD-driving-ability selection circuit (the Low-level voltage) 35 and outputs selection signals to them. The CCD-driving-ability selection circuit (the Middle-level voltage) 34 and the CCD-driving-ability selection circuit (the Low-level voltage) 35 are driven and controlled by the selection signals from the second control circuit 39.

The selection signals from the second control circuit 39 are used for varying the ON resistances of the output transistors in the Middle-level output driver 37 and the Low-level output driver 38, as described in the first embodiment. This is because, in the case where the dual-purpose binary/ternary output blocks are used as binary output blocks, it is necessary to make the ON resistances of the output transistors smaller than in cases where they are used as ternary output blocks. Accordingly, in the case where the dual-purpose binary/ternary output blocks are used as binary output blocks, when the Middle-level voltage is outputted, two output transistors 37a and 37b in the Middle-level output driver 37 are used in parallel, through the CCD-driving-ability selection circuit (the Middle-level voltage) 34. Further, when the Low-level voltage is outputted, two output transistors 38a and 38b in the Low-level output driver 38 are used in parallel, through the CCD-driving-ability selection circuit (the Low-level voltage) 35. With the image pickup apparatus having the structure according to the second embodiment, in the case where the dual-purpose binary/ternary output blocks are used as binary output blocks, it is possible to reduce the ON resistances of the output transistors in the Middle-level output driver 37 and the Low-level output driver 38 to desired values, in order to properly drive the CCD.

Further, in the image pickup apparatus according to the second embodiment, in the case where the dual-purpose binary/ternary output blocks are used as ternary output blocks, a single output transistor 36a in the High-level output driver 36 is used, a single output transistor 37a in the Middle-level output driver 37 is used, and a single output transistor 38a in the Low-level output driver 38 is used.

The technical means for the vertical driver 60 in the image pickup apparatus according to the second embodiment is effective means usable for structuring a vertical driver to be capable of being changed over between two types of patterns, in cases where an existing ternary output block is used as a binary output block.

As described above, the image sensor driving apparatus according to the present invention is a semiconductor integrated device for driving vertical registers in a CCD (Charge Coupled Device) and includes a plurality of High-level output drivers, a plurality of Middle-level output drivers and a plurality of Low-level output drivers which are connected to a common output connected to the CCD, wherein the High-level output drivers, the Middle-level output drivers and the Low-level output drivers are output drivers for outputting a High-level voltage, a Middle-level voltage and a Low-level voltage for driving the CCD. Further, the image sensor driving apparatus according to the present invention includes a first control circuit for selectively outputting the three types of levels from the High-level output drivers, the Middle-level output drivers and the Low-level output drivers, wherein the three values of a High-level voltage, a Middle-level voltage and a Low-level voltage can be outputted to the output according to the first control circuit. The image sensor driving apparatus according to the present invention further includes a selection circuit which drives the High-level output drivers, the Middle-level output drivers and the Low-level output drivers, according to the CCD driving ability. Further, the image sensor driving apparatus according to the present invention includes a second control circuit 2 which outputs control signals for driving arbitrary numbers of drivers, out of the High-level output drivers, the Middle-level output drivers and the Low-level output drivers, through the selection circuits and signals from the outside.

Further, the image sensor driving apparatus according to the present invention includes a plurality of dual-purpose binary/ternary output blocks each constituted by the first control circuit, the second control circuit, the High-level output drivers, the Middle-level output drivers, the Low-level output drivers, and the selection circuit.

Further, in the image sensor driving apparatus according to the present invention, the High-level output drivers, the Middle-level output drivers, and the Low-level output drivers are constituted by N-channel or P-channel MOS transistors.

In the image sensor driving apparatus according to the present invention, the High-level output drivers, the Middle-level output drivers, and the Low-level output drivers are constituted by N-channel or P-channel MOS transistors and, also, are connected to respective level voltages and respective output terminals.

In the image sensor driving apparatus according to the present invention, the selection circuit is included in the dual-purpose binary/ternary output blocks for changing the ability to drive a CCD image sensor.

In the image sensor driving apparatus according to the present invention, the second control circuit has a number of input terminals corresponding to the number of changeovers among abilities to drive the CCD image sensor.

### Third Embodiment

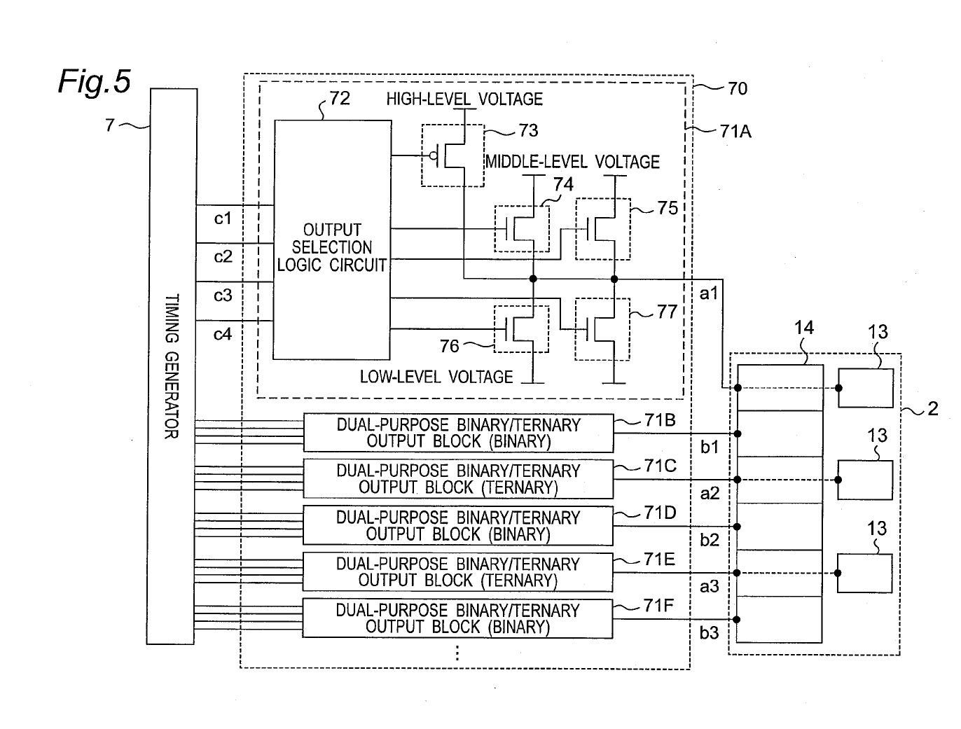

Hereinafter, with reference to FIG. 5, a third embodiment of the present invention will be described, with respect to an image pickup apparatus using an image sensor driving apparatus which is a semiconductor integrated device.

FIG. 5 is a block diagram illustrating the structures of a vertical driver 70 and peripheral devices therefor, in the image pickup apparatus according to the third embodiment of the present invention. As illustrated in FIG. 5, the vertical driver 70 is provided with a plurality of dual-purpose binary/ternary output blocks, according to the specifications of the CCD image sensor 2. In the image pickup apparatus according to the third embodiment, the structures of the other portions than the vertical driver 70 are the same as those of the image pickup apparatus according to the first embodiment illustrated in FIG. 1. In the image pickup apparatus according to the third embodiment, the components having the same functions and structures as those of the components of the image pickup apparatus according to the aforementioned first embodiment will be designated by the same reference characters, and the description of the first embodiment will be applied thereto.

As illustrated in FIG. 5, a timing generator 7 inputs driving/controlling signals to a plurality of dual-purpose binary/ternary output blocks 71A, 71B, 71C, . . . in the vertical driver 70. In FIG. 5, there is illustrated a block diagram illustrating, as a representative embodiment, the structure of one of the plurality of dual-purpose binary/ternary output blocks 71A, 71B, 71C, . . . provided in the vertical driver 70. The dual-purpose binary/ternary output block 71A includes an output selection logic circuit 72 which selects utilizing the dual-purpose binary/ternary output block 71A as a binary output block or utilizing it as a ternary output block. The timing generator 7 inputs, to the output selection logic circuit 72, driving/controlling signals c1, c2, c3 and c4 for driving and controlling the vertical driver 70. Further, the dual-purpose binary/ternary output block 71A includes a High-level output driver 73, a Middle-level output driver 74, a binary dedicated Middle-level output driver 75, a Low-level output driver 76 and a binary dedicated Low-level output driver 77. Further, each of the output drivers 73 to 77 is constituted by an output transistor.

The High-level output driver 73 is a transistor circuit which outputs a High-level voltage (for example, +12 V) to the CCD image sensor 2, according to control signals from the output selection logic circuit 72. The output transistor in the High-level output driver 73 is constituted by a P-ch MOS transistor. The Middle-level output driver 74 is a transistor circuit which outputs a Middle-level voltage (for example, 0 V) to the CCD image sensor 2, according to control signals from the output selection logic circuit 72. The Low-level output driver 76 is a transistor circuit which outputs a Low-level voltage (for example, −6 V) to the CCD image sensor 2, according to control signals from the output selection logic circuit 72.

The binary dedicated Middle-level output driver 75 is a transistor circuit which outputs a Middle-level voltage to the CCD image sensor 2, by being excited together with the Middle-level output driver 74 by control signals from the output selection logic circuit 72, in the case where the dual-purpose binary/ternary output block 71A functions as a binary output block. The binary dedicated Low-level output driver 77 is a transistor circuit which outputs a Low-level voltage to the CCD image sensor 2, by being excited together with the Low-level output driver 76 by control signals from the output selection logic circuit 72, in the case where the dual-purpose binary/ternary output block 71A functions as a binary output block.

There are provided a plurality of output blocks having the same structure as that of the dual-purpose binary/ternary output block 71A having the aforementioned structure to form the vertical driver 70. In the vertical driver 70 illustrated in FIG. 5, the dual-purpose binary/ternary output block 71A illustrated in the uppermost stage is used for readout and transfer from a photo diode 13 to a vertical register 14 and for vertical transfer through the vertical register 14 in the CCD image sensor 2 and, therefore, operates as a ternary output block. In FIG. 5, the dual-purpose binary/ternary output block 71A illustrated in the uppermost stage outputs a ternary vertical driving pulse a1 to the photo diode 13 and the vertical register 14.

In the vertical driver 70 in FIG. 5, the dual-purpose binary/ternary output block 71B illustrated in the second stage is used for vertical transfer through a vertical register 14 in the CCD image sensor 2 and, therefore, operates as a binary output block. The dual-purpose binary/ternary output block 71B outputs a binary vertical driving pulse b1 to the vertical register 14.

As described above, the determination as to whether the dual-purpose binary/ternary output blocks 71A, 71B, 71C, . . . in the vertical driver 70 should function as binary output blocks or ternary output blocks is made, according to the specifications of the corresponding CCD image sensor 2. Further, in FIG. 5, the ternary vertical driving pulses outputted from the dual-purpose binary/ternary output blocks 71A, 71B, 71C, . . . are designated as a1, a2 and a3, while the binary vertical driving pulses are designated as b1, b2 and b3.

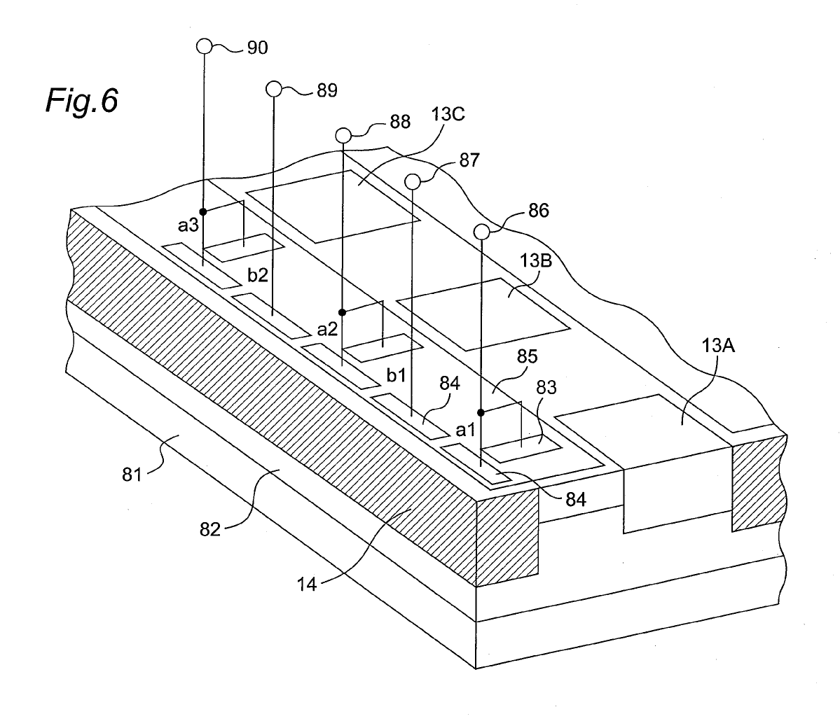

FIG. 6 is a view illustrating the cross-sectional structure of the CCD image sensor 2 having the photo diodes 13 and the vertical registers 14 illustrated in FIG. 5. In FIG. 6, a reference character 81 designates an N-type substrate, a reference character 82 designates a P-type well, a reference character 83 designates readout gates, a reference character 84 designates transfer gates, and a reference character 85 designates a light interception layer. The readout gates 83 and the transfer gates 84 are connected to respective input terminals 86, 87, 88, . . . . Further, in FIG. 6, the photo diodes are designated as 13A, 13B, 13C. The ternary vertical driving pulses a1, a2 and a3 from the vertical driver 70 are inputted to the corresponding readout gates 83 and transfer gates 84. The binary vertical driving pulses b1 and b2 from the vertical driver 70 are inputted to the corresponding transfer gates 84.

In the CCD image sensor 2 illustrated in FIG. 6, the signal charge accumulated in the photo diode 13A is transferred from the photo diode 13A to the vertical register 14, by the High-level voltage applied to the readout gate 83 through the input terminal 86. The transferred signal charge is successively transferred toward the horizontal register along the vertical register 14. When signal charges are transferred, the transfer is performed by changing over between the binary signals having the Middle-level voltage and the Low-level voltage at the input terminals 87, 88, 89 . . . .

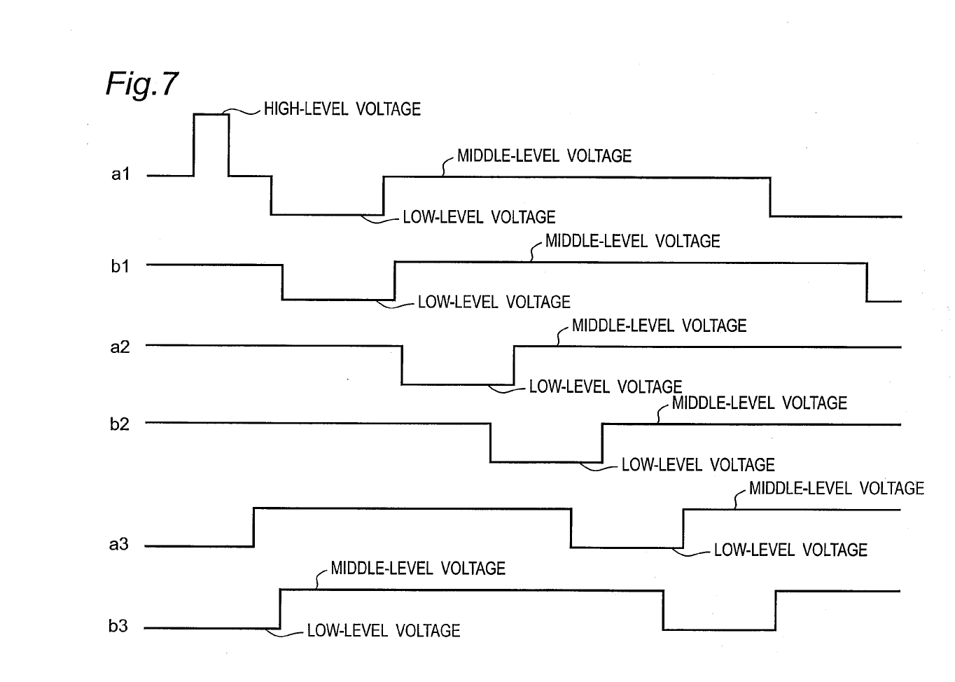

FIG. 7 is a timing chart of the vertical driving pulses a1, a2, a3, b1, b2 and b3 which are driving signals inputted to the CCD image sensor 2. FIG. 7 illustrates an embodiment of the timing chart of the vertical driving pulses a1, a2, a3, b1, b2 and b3 when signal charges are transferred in the CCD image sensor 2.

Next, there will be described the operations of the vertical driver 70 in the image pickup apparatus having the aforementioned structure according to the third embodiment.

### [Operations of Ternary Output Block]

At first, there will be described a case where a dual-purpose binary/ternary output block (for example, the dual-purpose binary/ternary output block 71A in the uppermost stage in FIG. 5) in the vertical driver 70 is operated as a ternary output block. There will be described a case where the dual-purpose binary/ternary output block 71A as a ternary output block outputs a High-level voltage (+12 V), the Middle-level voltage (0V) or the Low-level voltage (−6V) to a photo diodes 13 and a vertical register 14 in the CCD image sensor 2, as operations which will be described later.

The timing generator 7 is configured to input driving/controlling signals c1, c2, c3 and c4 to the dual-purpose binary/ternary output block 71A. The driving/controlling signals c1 and c2 are input signals in the case where it operates as a ternary output block. The driving/controlling signal c3 is an input signal in the case where it operates as a binary output block. The driving/controlling signal c4 is an input signal which selects using the dual-purpose binary/ternary output block 71A as a ternary output block or using it as a binary output block. In the case where the dual-purpose binary/ternary output block 71A is used as a ternary output block, the driving/controlling signal c4 is a signal having a GND-level voltage (0V), for example. On the other hand, in the case where the dual-purpose binary/ternary output block 71B is used as a binary output block, the driving/controlling signal c4 is a signal having a VDC voltage (for example, +3.3 V).

Further, the respective driving/controlling signals c1, c2, c3 and c4 inputted from the timing generator 7 are signals indicative of the VDC voltage or the GND-level voltage.

[Output of High-Level Voltage from Ternary Output Block]

There will be described the operations for causing the dual-purpose binary/ternary output block 71A, as a ternary output block, to output the High-level voltage. In the case where it is caused to output the High-level voltage, the driving/controlling signal c1 having the GND-level voltage and the driving/controlling signal c2 having the GND-level voltage are inputted to the dual-purpose binary/ternary output block 71A. Since the driving/controlling signal c3 is an input signal for operating it as a binary output block, the driving/controlling signal c3 is fixed as any of signals having the VDC voltage and the GND-level voltage, for the dual-purpose binary/ternary output block 71A which operates as a ternary output block. The driving/controlling signal C4 is a signal having the GND-level voltage for operating it as a ternary output block.

The driving/controlling signals c1, c2, c3 and c4 are inputted to the output selection logic circuit 72 in the dual-purpose binary/ternary output block 71A, so that the dual-purpose binary/ternary output block 71A operates as a ternary output block to output the High-level voltage.

The output selection logic circuit 72 to which the driving/controlling signals c1, c2, c3 and c4 have been inputted as described above applies voltages which will be described later to the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71A outputs the High-level voltage.

The Low-level voltage is applied to the gate of the output transistor in the High-level output driver 73, thereby turning on the output transistor in the High-level output driver 73. The Low-level voltage is applied to the gate of the output transistor in the Middle-level output driver 74, thereby turning off the output transistor in the Middle-level output driver 74. The Low-level voltage is applied to the gate of the output transistor in the Low-level output driver 76, thereby turning off the output transistor in the Low-level output driver 76. Further, the Low-level voltage is applied to the respective gates of the output transistor in the binary dedicated Middle-level output driver 75 and the output transistor in the binary dedicated Low-level output driver 77, thereby turning off the respective output transistors in the binary dedicated Middle-level output driver 75 and the binary dedicated Low-level output driver 77.

As described above, the output selection logic circuit 72 applies the desired voltages to the gates of the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71A as a ternary output block outputs the vertical driving pulse a1 having the High-level voltage.

[Output of Middle-Level Voltage from Ternary Output Block]

Next, there will be described the operations for causing the dual-purpose binary/ternary output block 71A, as a ternary output block, to output the Middle-level voltage.

In the case where the dual-purpose binary/ternary output block 71A is caused to output the Middle-level voltage, the driving/controlling signal c1 having the GND-level voltage and the driving/controlling signal c2 having the VDC voltage are inputted to the dual-purpose binary/ternary output block 71A. Since the driving/controlling signal c3 is an input signal for operating it as a binary output block, the driving/controlling signal c3 is fixed as any of signals having the VDC voltage and the GND-level voltage, for the dual-purpose binary/ternary output block 71A which operates as a ternary output block. The driving/controlling signal C4 is a signal having the GND-level voltage for operating it as a ternary output block.

The driving/controlling signals c1, c2, c3 and c4 are inputted to the output selection logic circuit 72 in the dual-purpose binary/ternary output block 71A, so that the dual-purpose binary/ternary output block 71A operates as a ternary output block to output the Middle-level voltage.

The output selection logic circuit 72 to which the driving/controlling signals c1, c2, c3 and c4 have been inputted as described above applies voltages which will be described later to the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71A outputs the Middle-level voltage.

The High-level voltage is applied to the gate of the output transistor in the High-level output driver 73, thereby turning off the output transistor in the High-level output driver 73. The High-level voltage is applied to the gate of the output transistor in the Middle-level output driver 74, thereby turning on the output transistor in the Middle-level output driver 74. The Low-level voltage is applied to the gate of the output transistor in the Low-level output driver 76, thereby turning off the output transistor in the Low-level output driver 76. Further, the Low-level voltage is applied to the respective gates of the output transistor in the binary dedicated Middle-level output driver 75 and the output transistor in the binary dedicated Low-level output driver 77, thereby turning off the respective output transistors in the binary dedicated Middle-level output driver 75 and the binary dedicated Low-level output driver 77.

As described above, the output selection logic circuit 72 applies the desired voltages to the gates of the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71A as a ternary output block outputs the vertical driving pulse a1 having the Middle-level voltage.

[Output of Low-Level Voltage from Ternary Output Block]

Next, there will be described the operations for causing the dual-purpose binary/ternary output block 71A, as a ternary output block, to output the Low-level voltage.

In the case where the dual-purpose binary/ternary output block 71A is caused to output the Low-level voltage, the driving/controlling signal c1 having the VDC voltage and the driving/controlling signal c2 having the VDC voltage are inputted to the dual-purpose binary/ternary output block 71A. Since the driving/controlling signal c3 is an input signal for operating it as a binary output block, the driving/controlling signal c3 is fixed as any of signals having the VDC voltage and the GND-level voltage, for the dual-purpose binary/ternary output block 71A which operates as a ternary output block. The driving/controlling signal C4 is a signal having the GND-level voltage for operating it as a ternary output block.

The driving/controlling signals c1, c2, c3 and c4 are inputted to the output selection logic circuit 72 in the dual-purpose binary/ternary output block 71A, so that the dual-purpose binary/ternary output block 71A operates as a ternary output block to output the Low-level voltage.

The output selection logic circuit 72 to which the driving/controlling signals c1, c2, c3 and c4 have been inputted as described above applies voltages which will be described later to the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71A outputs the Low-level voltage.

The High-level voltage is applied to the gate of the output transistor in the High-level output driver 73, thereby turning off the output transistor in the High-level output driver 73. The Low-level voltage is applied to the gate of the output transistor in the Middle-level output driver 74, thereby turning off the output transistor in the Middle-level output driver 74. The High-level voltage is applied to the gate of the output transistor in the Low-level output driver 76, thereby turning on the output transistor in the Low-level output driver 76. Further, the Low-level voltage is applied to the respective gates of the output transistors in the binary dedicated Middle-level output driver 75 and the binary dedicated Low-level output driver 77, thereby turning off the output transistors in the binary dedicated Middle-level output driver 75 and the binary dedicated Low-level output driver 77.

As described above, the output selection logic circuit 72 applies the desired voltages to the gates of the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71A as a ternary output block outputs the vertical driving pulse a1 having the Low-level voltage.

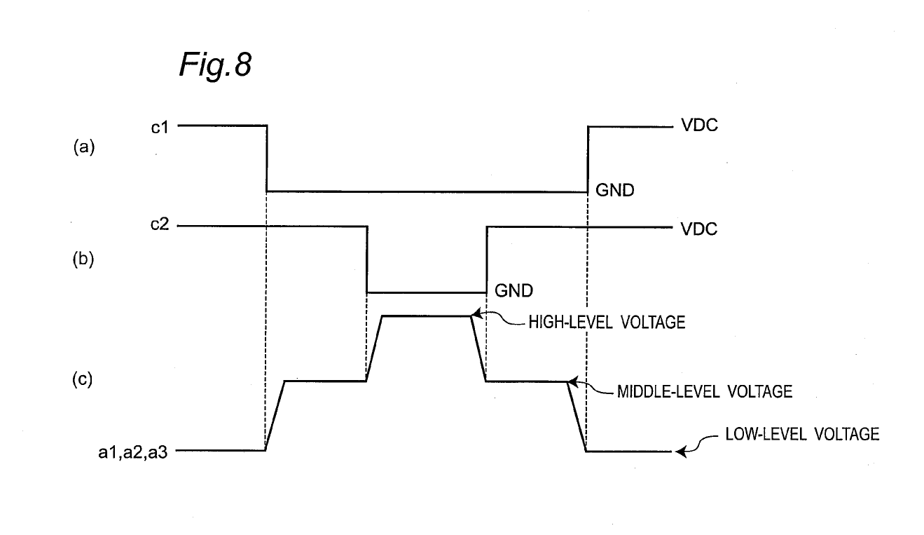

FIG. 8 is a timing chart illustrating the relationship between the input and output voltage waveforms to and from the dual-purpose binary/ternary output block 71A in the vertical driver 70 illustrated in FIG. 5. FIG. 8 is a case where the driving/controlling signal c4 having the GND-level voltage is inputted to the dual-purpose binary/ternary output block 71A, so that it functions as a ternary output block. In FIG. 8, (a) is the driving/controlling signal c1 which is inputted to the dual-purpose binary/ternary output block 71A, (b) is the driving/controlling signal c2, and (c) is the ternary vertical driving pulses a1, a2 and a3 which are driving signals outputted from the dual-purpose binary/ternary output block 71A.

As described above, the dual-purpose binary/ternary output block 71A in the vertical driver 70 according to the third embodiment performs operations similar to those of a ternary output block which outputs any of the three types of voltages which are the High-level voltage, the Middle-level voltage and the Low-level voltage, since the driving/controlling signal c4 inputted thereto is set to the GND-level voltage.

In the case where the dual-purpose binary/ternary output block 71A operates as a ternary output block, as illustrated in FIG. 8, when the driving/controlling signals c1 and c2 are both at the VDC voltage, the vertical driving pulses a1, a2 and a3 as the output signals are having the Low-level voltage. When the driving/controlling signal c1 is at the GND-level voltage, and the driving/controlling signal c2 is at the VDC voltage, the vertical driving pulses a1, a2 and a3 as the output signals are at the Middle-level voltage. Further, when the driving/controlling signals c1 and c2 are both at the GND-level voltage, the vertical driving pulses a1, a2 and a3 as the output signals are at the High-level voltage.

As described above, the desired driving/controlling signals c1, c2, c3 and c4 are inputted to the dual-purpose binary/ternary output block 71A in the vertical driver 70 in the image pickup apparatus according to the third embodiment, the dual-purpose binary/ternary output block as a ternary output block can output, to the CCD image sensor 2, any of the Low-level voltage, the Middle-level voltage and the High-level voltage.

[Operations of Binary Output Block]

Next, hereinafter, there will be described a case where a dual-purpose binary/ternary output block (for example, the dual-purpose binary/ternary output block 71B in the second stage in FIG. 5) in the vertical driver 70 is operated as a binary output block. There will be described a case where the dual-purpose binary/ternary output block 71B as a binary output block outputs the Middle-level voltage (0V) or the Low-level voltage (−6V) to a vertical register 14 in the CCD image sensor 2, as operations which will be described later. Further, the dual-purpose binary/ternary output block 71B has the same structure as that of the dual-purpose binary/ternary output block 71A illustrated in FIG. 5 and, therefore, will be described using the reference characters illustrated in FIG. 5.

The timing generator 7 is configured to input driving/controlling signals c1, c2, c3 and c4 having the VDC voltage or the GND-level voltage to the dual-purpose binary/ternary output block 71B in the vertical driver 70, similarly to for the other dual-purpose binary/ternary output blocks.

[Output of Middle-Level Voltage from Binary Output Block]

Since the driving/controlling signals c1 and c2 inputted to the dual-purpose binary/ternary output block 71B are input signals for operating it as a ternary output block, the driving/controlling signals c1 and c2 are fixed as any of signals having the VDC voltage and the GND-level voltage, for the dual-purpose binary/ternary output block 71B which operates as a binary output block. In the case where it is caused to output the Middle-level voltage, the driving/controlling signal c3 having the GND-level voltage is inputted to the dual-purpose binary/ternary output block 71B. The driving/controlling signal C4 is a signal having the VDC voltage for operating it as a binary output block.

The driving/controlling signals c1, c2, c3 and c4 are inputted to the output selection logic circuit 72 in the dual-purpose binary/ternary output block 71B, so that the dual-purpose binary/ternary output block 71B operates as a binary output block to output the Middle-level voltage.

The output selection logic circuit 72 in the dual-purpose binary/ternary output block 71B to which the driving/controlling signals c1, c2, c3 and c4 have been inputted as described above applies voltages which will be described later to the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71B outputs the Middle-level voltage.

The High-level voltage is applied to the gate of the output transistor in the High-level output driver 73, thereby turning off the output transistor in the High-level output driver 73. The High-level voltage is applied to the gate of the output transistor in the Middle-level output driver 74, thereby turning on the output transistor in the Middle-level output driver 74. The Low-level voltage is applied to the gate of the output transistor in the Low-level output driver 76, thereby turning off the output transistor in the Low-level output driver 76. The High-level voltage is applied to the gate of the output transistor in the binary dedicated Middle-level output driver 75, thereby turning on the output transistor in the binary dedicated Middle-level output driver 75. Further, the Low-level voltage is applied to the gate of the output transistor in the binary dedicated Low-level output driver 77, thereby turning off the output transistor in the binary dedicated Low-level output driver 77.

As described above, the output selection logic circuit 72 applies the desired voltages to the gates of the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71B as a binary output block outputs the vertical driving pulse b1 having the Middle-level voltage. That is, when the dual-purpose binary/ternary output block 71B as a binary output block outputs the Middle-level voltage, the Middle-level output driver 74 and the binary dedicated Middle-level output driver 75 are excited, thereby reducing the ON resistance of the output transistors when the Middle-level voltage is outputted.

[Output of Low-Level Voltage from Binary Output Block]

Next, in the case where the dual-purpose binary/ternary output block 71B is caused to output the Low-level voltage, since the driving/controlling signals c1 and c2 are input signals for operating it as a ternary output block, the driving/controlling signals c1 and c2 are fixed to any of signals having the VDC voltage and the GND-level voltage, for the dual-purpose binary/ternary output block 71B which operates as a binary output block. When it is caused to output the Low-level voltage, the driving/controlling signal C3 having the VDC voltage is inputted to the dual-purpose binary/ternary output block 71B. The driving/controlling signal C4 is a signal having the VDC voltage for operating it as a binary output block.

The driving/controlling signals c1, c2, c3 and c4 are inputted to the output selection logic circuit 72 in the dual-purpose binary/ternary output block 71B, so that the dual-purpose binary/ternary output block 71B operates as a binary output block to output the Low-level voltage.

The output selection logic circuit 72 in the dual-purpose binary/ternary output block 71B to which the driving/controlling signals c1, c2, c3 and c4 have been inputted as described above applies voltages which will be described later to the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71B outputs the Low-level voltage.

The High-level voltage is applied to the gate of the output transistor in the High-level output driver 73, thereby turning off the output transistor in the High-level output driver 73. The Low-level voltage is applied to the gate of the output transistor in the Middle-level output driver 74, thereby turning off the output transistor in the Middle-level output driver 74. The High-level voltage is applied to the gate of the output transistor in the Low-level output driver 76, thereby turning on the output transistor in the Low-level output driver. The Low-level voltage is applied to the gate of the output transistor in the binary dedicated Middle-level output driver 75, thereby turning off the output transistor in the binary dedicated Middle-level output driver 75. The High-level voltage is applied to the gate of the output transistor in the binary dedicated Low-level output driver 77, thereby turning on the output transistor in the binary dedicated Low-level output driver 77.

As described above, the output selection logic circuit 72 applies the desired voltages to the gates of the respective output transistors in the High-level output driver 73, the Middle-level output driver 74, the binary dedicated Middle-level output driver 75, the Low-level output driver 76 and the binary dedicated Low-level output driver 77, so that the dual-purpose binary/ternary output block 71B as a binary output block outputs the vertical driving pulse b1 having the Low-level voltage. That is, when the dual-purpose binary/ternary output block 71B as a binary output block outputs the Low-level voltage, the Low-level output driver 76 and the binary dedicated Low-level output driver 77 are excited, thereby reducing the ON resistance of the output transistors when the Low-level voltage is outputted.

With the vertical driver 70 in the image pickup apparatus according to the third embodiment, in the case where the dual-purpose binary/ternary output block 71B is operated as a binary output block, when the Middle-level voltage is outputted therefrom, the output transistors in the Middle-level output driver 74 and the binary dedicated Middle-level output driver 75 are both excited, while, when the Low-level voltage is outputted therefrom, the output transistors in the Low-level output driver 76 and the binary dedicated Low-level output driver 77 are both excited. As described above, the vertical driver 70 according to the third embodiment is configured such that the output transistor in the binary dedicated Middle-level output driver or the output transistor in the binary dedicated Low-level output driver is turned on, which increases the number of transistors which output the Middle-level voltage and the Low-level voltage. This results in reduction of the ON resistances of the output transistors when the Middle-level voltage and the Low-level voltage are outputted, thereby realizing suitable ON resistance values necessary for operations as a binary output block.

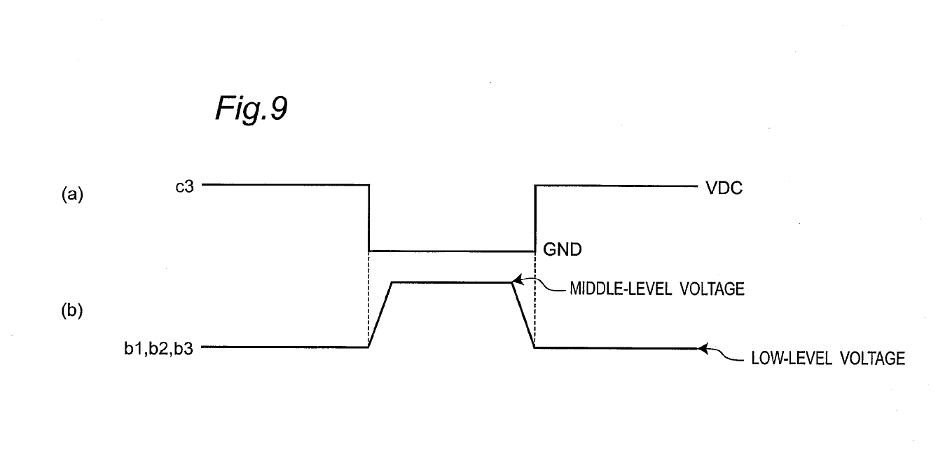

FIG. 9 is a timing chart illustrating the relationship between the input and output voltage waveforms to and from the dual-purpose binary/ternary output block 71B in the vertical driver 70 illustrated in FIG. 5. FIG. 9 is a case where the driving/controlling signal c4 having the VDC voltage is inputted to the dual-purpose binary/ternary output block 71B, so that it functions as a binary output block. In FIG. 9, (a) is the driving/controlling signal c3 which is inputted to the dual-purpose binary/ternary output block 71B, and (b) is the binary vertical driving pulses b1, b2 and b3 which are driving signals outputted from the dual-purpose binary/ternary output block 71B.

The dual-purpose binary/ternary output block 71B in the vertical driver 70 according to the third embodiment performs operations similar to those of a binary output block which outputs any of the two types of voltages which are the Middle-level voltage and the Low-level voltage, since the driving/controlling signal c4 inputted thereto is set to the VDC voltage.

In the case where the dual-purpose binary/ternary output block operates as a binary output block, as illustrated in FIG. 9, when the driving/controlling signal c3 is at the VDC voltage, the vertical driving pulses b1, b2 and b3 are at the Low-level voltage. On the other hand, when the driving/controlling signal c3 is at the GND-level voltage, the vertical driving pulses b1, b2 and b3 are at the Middle-level voltage.

In the case where the dual-purpose binary/ternary output block 71B in the vertical driver 70 according to the third embodiment is operated as a binary output block, the binary dedicated Middle-level output driver 75 and the binary dedicated Low-level output driver 77 are activated, which adjusts the rising waveforms and the trailing waveforms of the vertical driving pulses, thereby setting the driving abilities of the respective output drivers 75 and 77 to have ON resistances suitable for binary operations.

### Fourth Embodiment

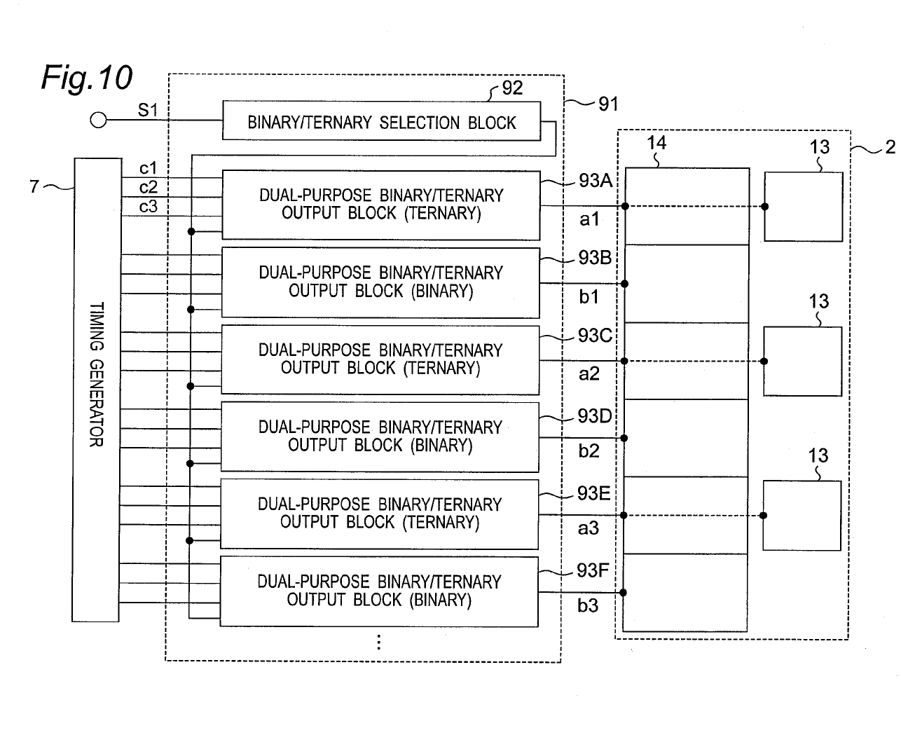

Hereinafter, with reference to FIG. 10, a fourth embodiment of the present invention will be described, with respect to an image pickup apparatus using an image sensor driving apparatus which is a semiconductor integrated device.

FIG. 10 is a block diagram illustrating the structures of a vertical driver 91 and peripheral devices therefor, in the image pickup apparatus according to the fourth embodiment of the present invention. As illustrated in FIG. 10, the vertical driver 91 is provided with a plurality of dual-purpose binary/ternary output blocks 93A, 93B, 93C, . . . , according to the specifications of a CCD image sensor 2. In the image pickup apparatus according to the fourth embodiment, the structures of the other portions than the vertical driver 91 are the same as those of the image pickup apparatus according to the first embodiment illustrated in FIG. 1. In the image pickup apparatus according to the fourth embodiment, the components having the same functions and structures as those of the components of the image pickup apparatus according to the aforementioned first embodiment will be designated by the same reference characters, and the description of the first embodiment will be applied thereto.

As illustrated in FIG. 10, a timing generator 7 inputs driving/controlling signals c1, c2 and c3 to the plurality of dual-purpose binary/ternary output blocks 93A, 93B, 93C, . . . in the vertical driver 91. The vertical driver 91 according to the fourth embodiment is provided with a binary/ternary selection block 92 having a storage device, in addition to the plurality of dual-purpose binary/ternary output blocks 93A, 93B, 93C, . . . . Selection signals S1 from the outside of the apparatus are inputted to the binary/ternary selection block 92. The selection signals S1 are setting signals for setting as to whether the corresponding dual-purpose binary/ternary output blocks should be operated as binary output blocks or ternary output blocks. Further, the driving/controlling signals c1, c2 and c3 have the same functions as those of the driving/controlling signals c1, c2 and c3 which have been described in the aforementioned third embodiment (see FIGS. 8 and 9).

The dual-purpose binary/ternary output blocks 93A, 93B, 93C, . . . include a High-level output driver, a Middle-level output driver, a binary dedicated Middle-level output driver, a Low-level output driver and a binary dedicated Low-level output driver, similarly to in the aforementioned third embodiment.

The binary/ternary selection block 92 includes the storage device and is configured to be capable of setting, according to the selection signals S1 form the outside, whether the respective dual-purpose binary/ternary output blocks 93A, 93B, 93C, . . . should be operated as ternary output blocks or binary output blocks.

Accordingly, all the settings of the channels of the dual-purpose binary/ternary output blocks 93A, 93B, 93C, . . . can be temporarily stored in the binary/ternary selection block 92, according to the selection signals S1, which enables driving the CCD image sensor 2. Further, even if the specifications of the corresponding CCD image sensor 2 are changed, it is possible to cope therewith, by changing the data stored in the binary/ternary selection block 92 according to the selection signals S1.

### Fifth Embodiment

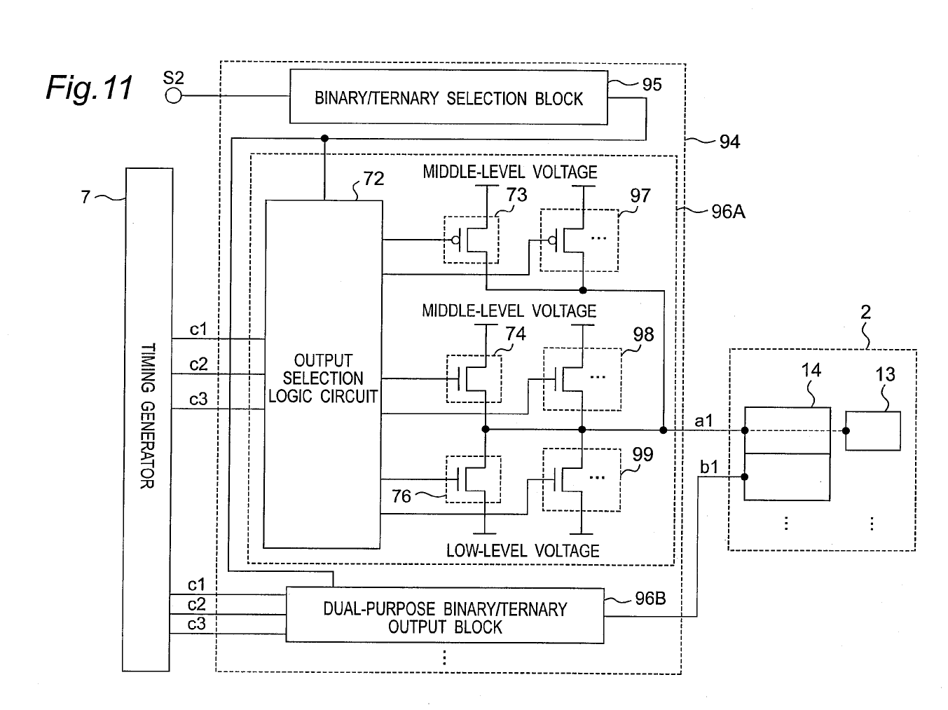

Hereinafter, with reference to FIG. 11, a fifth embodiment of the present invention will be described, with respect to an image pickup apparatus using an image sensor driving apparatus which is a semiconductor integrated device.

FIG. 11 is a block diagram illustrating the structures of a vertical driver 94 and peripheral devices therefor, in the image pickup apparatus according to the fifth embodiment of the present invention. As illustrated in FIG. 11, the vertical driver 94 is provided with a plurality of dual-purpose binary/ternary output blocks 96A, 96B, . . . according to the specifications of a CCD image sensor 2. In the image pickup apparatus according to the fifth embodiment, the structures of the other portions than the vertical driver 94 are the same as those of the image pickup apparatus according to the first embodiment illustrated in FIG. 1. In the image pickup apparatus according to the fifth embodiment, the components having the same functions and structures as those of the components of the image pickup apparatus according to the aforementioned first embodiment will be designated by the same reference characters, and the description of the first embodiment will be applied thereto.

As illustrated in FIG. 11, a timing generator 7 inputs driving/controlling signals c1, c2 and c3 to the plurality of dual-purpose binary/ternary output blocks 96A, 96B, . . . in the vertical driver 94. The vertical driver 94 according to the fifth embodiment is provided with a binary/ternary selection block 95 having a storage device, in addition to the plurality of dual-purpose binary/ternary output blocks 96A, 96B, . . . . Selection signals S2 from the outside of the apparatus are inputted to the binary/ternary selection block 95. The selection signals S2 are setting signals for setting whether the corresponding dual-purpose binary/ternary output blocks should be operated as binary output blocks or ternary output blocks and, also, are setting signals for setting suitable ON resistances for the respective output levels of the corresponding dual-purpose binary/ternary output blocks. Further, the driving/controlling signals c1, c2 and c3 have the same functions as those of the driving/controlling signals c1, c2 and c3 which have been described in the aforementioned third embodiment (see FIGS. 8 and 9).

As illustrated in FIG. 11, the dual-purpose binary/ternary output blocks 96A, 96B, . . . include an output selection logic circuit 72, a High-level output driver 73, a Middle-level output driver 74 and a Low-level output driver 76. Further, each dual-purpose binary/ternary output block 96A, 96B, . . . includes an ability adjustment High-level output driver 97, an ability adjustment Middle-level output driver 98 and an ability adjustment Middle-level output driver 99. While, in FIG. 11, there is illustrated the structure of only the binary/ternary output driver 96A, the other dual-purpose binary/ternary output blocks also have the same structure.

In the vertical driver 94 in the image pickup apparatus according to the fifth embodiment, the driving/controlling signals c1, c2 and c3 are inputted from the timing generator 7 to the output selection logic circuit 72 and, further, selection signals are inputted thereto from the binary/ternary selection block 95. The output selection logic circuit 72, to which the driving/controlling signals c1, c2 and c3 and the selection signals are inputted, is configured to excite the output transistor in the ability adjustment High-level output driver 97, the ability adjustment Middle-level output driver 98 or the ability adjustment Low-level output driver 99 at the respective output levels, in order to properly drive the CCD image sensor 2 at the respective output levels. That is, the output selection logic circuit 72 adjusts the ON resistance of the output transistor in each output driver, according to the corresponding CCD, based on the selection signals S2 inputted from the outside.

As described above, with the vertical driver 94 in the image pickup apparatus according to the fifth embodiment, it is possible to perform fine adjustments of the ON resistances of the output transistors in the respective output drivers, through selection signals from the binary/ternary selection block 95, thereby enabling structuring a fully-programmable vertical driver.

As described in the aforementioned respective embodiments, with the present invention, in order to properly drive the CCD image sensor, the vertical driver is provided with the plurality of dual-purpose binary/ternary output blocks, the respective output terminals of the dual-purpose binary/ternary output blocks are connected to the readout gates and the transfer gates in the CCD image sensor and, also, control signals are inputted to the respective dual-purpose binary/ternary output blocks. With the present invention, since the plurality of dual-purpose binary/ternary output blocks are prepared, it is possible to arbitrarily use these dual-purpose binary/ternary output blocks as ternary output blocks or binary output blocks, according to the specifications of various types of CCD image sensors.

With the image sensor driving apparatus according to the present invention, even if the positions of the readout gates of the photo diodes are changed in the structure of the CCD image sensor and, thus, the dual-purpose binary/ternary output blocks are changed over between binary output and ternary output, it is possible to flexibly change over the dual-purpose binary/ternary output blocks between ternary output and binary output, through signals from the timing generator and the like.

Since the CCD connected to the output terminal of the vertical driver as the image sensor driving apparatus according to the present invention can be equivalently replaced with a capacitance, the rising time and the trailing time at the changeover of the output level voltage from the vertical driver are determined by the time constant “RC”, assuming that the ON resistance of the output transistors in the vertical driver is “R”, and the capacitance of the CCD is “C”. The capacitance of the CCD is varied according to the type of the device, such as binary output blocks or ternary output blocks, the CCD driving mechanism, and the like. Therefore, by structuring the dual-purpose binary/ternary output blocks as described in the respective embodiments, it is possible to set the ON resistances of the output transistors to be suitable for the CCD image-sensor driving mechanism, thereby structuring a programmable vertical driver.

### INDUSTRIAL APPLICABILITY

With the present invention, it is possible to structure an image sensor driving apparatus using a single semiconductor integrated circuit and it is possible to adjust an ON resistances of an output transistors, thereby providing an effective image sensor driving apparatus applicable to a wide variety of fields.

1. An image sensor driving apparatus having a plurality of dual-purpose binary/ternary output blocks capable of outputting signals having binary or ternary voltage levels for driving an image sensor;
wherein the dual-purpose binary/ternary output blocks comprises
a first voltage-level output driver which outputs signals having a first voltage-level,
a second voltage-level output driver which outputs signals having a second voltage-level, and
a third voltage-level output driver which outputs signals having a third voltage-level, and
the dual-purpose binary/ternary output blocks are configured to perform, according to driving/controlling signals inputted thereto, binary outputting operations for outputting signals having the second voltage level or the third voltage level, or ternary outputting operations for outputting signals having the first voltage level, the second voltage level or the third voltage level.

2. The image sensor driving apparatus according to claim 1, wherein
the first voltage-level output driver, the second voltage-level output driver and the third voltage-level output driver are each configured to include a plurality of output transistors and are configured such that predetermined numbers of output transistors, out of the respective output transistors in the first voltage-level output driver, the second voltage-level output driver and the third voltage-level output driver, are activated according to the inputted driving/controlling signals.

3. The image sensor driving apparatus according to claim 1, wherein
the second voltage-level output driver and the third voltage-level output driver are each configured to include a plurality of output transistors, and the second voltage-level output driver and the third voltage-level output driver are configured such that the plurality of output transistors are activated therein, when the dual-purpose binary/ternary output blocks perform binary outputting operations.

4. The image sensor driving apparatus according to claim 1, wherein
the second voltage-level output driver comprises a binary dedicated second voltage-level output driver,
the third voltage-level output driver comprises a binary dedicated third voltage-level output driver, and
only when the dual-purpose binary/ternary output blocks perform binary outputting operations, the binary dedicated second voltage-level output driver is activated together with the second voltage-level output driver, or the binary dedicated third voltage-level output driver is activated together with the third voltage-level output driver.

5. The image sensor driving apparatus according to claim 1, wherein
a setting for causing the dual-purpose binary/ternary output blocks to perform binary outputting operations or ternary outputting operations is made, according to selection signals from an outside of the apparatus.

6. The image sensor driving apparatus according to claim 5, wherein
the dual-purpose binary/ternary output blocks include a storage device and are configured to store information about the selection signals indicative of whether the dual-purpose binary/ternary output blocks perform binary outputting operations or ternary outputting operations.

7. The image sensor driving apparatus according to claim 1, wherein
the first voltage-level output driver includes an ability adjustment first voltage-level output driver,
the second voltage-level output driver includes an ability adjustment second voltage-level output driver,
the third voltage-level output driver includes an ability adjustment third voltage-level output driver,
the image sensor driving apparatus is configured that the ability adjustment first voltage-level output driver, the ability adjustment second voltage-level output driver and the ability adjustment third voltage-level output driver are activated, according to the ability to drive the image sensor, according to driving/controlling signals from the outside of the apparatus, and
the dual-purpose binary/ternary output blocks are set to perform binary outputting operations or ternary outputting operations, according to selection signals from the outside of the apparatus.

8. The image sensor driving apparatus according to claim 7, wherein
the dual-purpose binary/ternary output blocks comprise a storage device and are configured to store information about the selection signals indicative of whether the dual-purpose binary/ternary output blocks perform binary outputting operations or ternary outputting operations.

9. The image sensor driving apparatus according to claim 1, wherein
the first voltage level is a High-level voltage, the second voltage level is a Middle-level voltage, and the third voltage level is a Low-level voltage, there is the relationship of the first voltage level>the second voltage level>the third voltage level, and the first voltage level, the second voltage level and the third voltage level are used for driving vertical registers of a CCD image sensor.

10. The image sensor driving apparatus according to claim 1, wherein
the first voltage-level output driver, the second voltage-level output driver and the third voltage-level output driver are constituted by N-channel or P-channel MOS transistors.
